(19) United States
(12) Patent Application Publication
(10) Pub. No.: US 2022/0222841 A1
(43) Pub. Date: Jul. 14, 2022

(54) METHOD AND SYSTEM FOR LIGHT FIELD IMAGING

(71) Applicant: INSTITUT NATIONAL DE LA RECHERCHE SCIENTIFIQUE, Quebec (CA)

(72) Inventors: Jinyang LIANG, Boucherville (CA); Jingdan LIU, Longueuil (CA); Shunmoogum A. PATTEN, Montreal (CA)

(21) Appl. No.: 17/568,488

(22) Filed: Jan. 4, 2022

Related U.S. Application Data
(60) Provisional application No. 63/199,552, filed on Jan. 8, 2021.

(51) Int. Cl. G06T 7/557; G02B 26/08; G02B 26/10; H04N 13/282; H04N 5/225; H04N 9/04; H04N 13/296; H04N 13/156

(52) U.S. Cl. CPC G06T 7/557; G02B 26/0833; G02B 26/101; H04N 13/282; G06T 2207/10052; H04N 9/04; H04N 13/296; H04N 5/22541; H04N 13/156; H04N 5/2256

(57) ABSTRACT

A method and a system for broadband coded aperture light field imaging of an object, the method comprising illuminating the object with a broadband light source; imaging a broadband light emitted by the illuminated object and forming a first image of the object on an intermediate image plane, relaying the first image to a final image plane and forming a final image of the object on a camera placed at the final image plane. The system comprises a broadband light source that illuminates the object; a first and a second digital micromirror devices; a first 4f imaging system and a second 4f imaging system, symmetrical about an intermediate image plane, that image images broadband light from the illuminated object on the intermediate image plane and on a final image plane; and a high speed camera that captures images at the final image plane, the first digital micromirror device induced spatial dispersion being compensated by the second digital micromirror device, both digital micromirror devices being placed at the Fourier plane of the system.

### CROSS REFERENCE TO RELATED APPLICATIONS

This application claims benefit of U.S. provisional application Ser. No. 63/199,552, filed on Jan. 8, 2021. All documents above are incorporated herein in their entirety by reference.

### FIELD OF THE INVENTION

The present invention relates to light field imaging. More specifically, the present invention is concerned with a method and system for dispersion-eliminated coded-aperture light field imaging.

### BACKGROUND OF THE INVENTION

Light field imaging records two-dimensional (2D) spatial (x,y) and 2D angular (θ,φ) information of incident rays; this four-dimensional (4D) information allows multiple-perspective viewing, digital refocusing, and depth estimation. To date, light field imaging is widely implemented in microscopy, photography, and endoscopy. In current systems, microlens arrays (MLAs) are typically used to sample (x,y) information in a field of view and then fill in local voids with (θ,φ) information. Nonetheless, the induced trade-off poses challenges for microlens array-based light field imaging to attaining high spatial resolution and high angular resolution simultaneously.

Many efforts have been taken to capture 4D light fields with a camera's full pixel count to overcome this limitation. For example, coded-aperture light field (CALF) imaging systems use single or multiple masks to encode the systems' aperture; the light field image is then generated by using reconstruction algorithms. Despite retaining a camera's full pixel count, early coded-aperture light field (CALF) systems had various limitations, including low pattern-adaptability to scenes, long acquisition time, and additional error due to misalignment. To improve the flexibility, efficiency, and accuracy in coded-aperture light field (CALF) imaging, liquid crystal spatial light modulators (LC-SLMs) have been implemented for aperture encoding. Without any mechanically moving part, LC-SLMs eliminate the error from mask misalignment. However, these devices suffer major drawbacks in contrast due to imperfect polarization selectivity, stability due to the flicker noise, and speeds due to liquid crystals (LC)'s limited responsible time for example. Thus far, coded-aperture light field (CALF) imaging of dynamic scenes at video rate is rarely performed.

Digital micromirror devices (DMDs) are being used to solve these problems. As a 2D binary amplitude spatial light modulator (SLM), a digital micromirror device (DMD) consists of up to millions of micromirrors, each of which can be independently tilted to either +12° or −12° from its surface normal to reflect incident light to one of the two directions as an “ON” or “OFF” pixel. This operating principle enables digital micromirror devices (DMDs) to produce high-contrast binary images. As a micro-electromechanical system, a digital micromirror device (DMD) can generate binary patterns at up to tens of kilohertz. Leveraging these technical advantages, digital micromirror devices (DMDs) have been used in phase-space measurements. By placing a DMD on the Fourier plane to rapidly create and scan sub-apertures, light field images of a static three-dimensional (3D) object illuminated by a single-wavelength laser beam are recorded. However, acting as a diffraction grating, the DMD induces severe spatial dispersion in the acquired images for broadband light, which still limits light field imaging of static objects using monochromatic light.

There is still a need for a method and system for light field imaging.

### SUMMARY OF THE INVENTION

More specifically, in accordance with the present invention, there is provided a method for broadband coded aperture light field imaging of an object, comprising illuminating the object with a broadband light source; imaging a broadband light emitted by the illuminated object and forming a first image of the object on an intermediate image plane, relaying the first image to a final image plane and forming a final image of the object on a camera placed at the final image plane.

There is further provided a method for imaging an object, comprising light field acquisition of two-dimensional spatial (x,y) and two-dimensional angular (θ,φ) information of incident rays from the object and 3D reconstruction of the object, the method comprising, illuminating the object with a broadband light source and directing a broadband light emitted from the illuminated object to a first 4f system and a second 4f system, the first 4f system and the second 4f system being symmetrical about an intermediate image plane; wherein the light field acquisition comprises synchronizing a camera and a first digital micromirror device placed on a back focal plane of a first lens of the first 4f system; capturing light field images by opening sub-apertures of the first digital micromirror device one by one and loading all “OFF” pattern onto a second digital micromirror device placed on a back focal plane of a first lens of the second 4f system; the 3D reconstruction comprises, in a system calibration step, loading sub-aperture patterns onto the first digital micromirror device, and capturing sub-aperture images by a camera; extracting feature points in the sub-aperture images captured by the camera, determining a light field disparity ((Δxᵢ,Δyⱼ) and an angle (θᵢ,φⱼ) of each sub-aperture using a light field disparity (Δxᵢ, Δyⱼ) as: tanθᵢ=Δxᵢ/f, and tanφⱼ=Δyⱼ/f, where f is a focal length of the first lens of the first 4f system; and, in a digital refocusing step, reconstructing a focal image at a distance Δz from an actual focal plane, by shifting each sub-aperture image by xxᵢ=Δz taθᵢ, yⱼ=Δz tanφⱼ, and adding together resulting shifted images.

There is further provided a system for broadband coded aperture light field imaging of an dynamic object, comprising a broadband light source; a first and a second digital micromirror devices; a first 4f imaging system and a second 4f imaging system, symmetrical about an intermediate image plane; and a high speed camera; wherein the broadband light source illuminates the object, the first 4f imaging system and said second 4f imaging system images broadband light from the illuminated object on the intermediate image plane and on a final image plane; and the camera captures images at the final image plane, the first digital micromirror device induced spatial dispersion being compensated by the second digital micromirror device, both digital micromirror devices being placed at the Fourier plane of the system.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic view of a system according to an embodiment of an aspect of the present disclosure;

FIG. 2 show characterization of a system according to an embodiment of an aspect of the present disclosure: FIG. 2A is an image on an intermediate image plane; FIG. 2B is an image on a final image plane; FIG. 2C and 2D are averaged horizontal and vertical line profiles of selected elements on the resolution target marked by lines 20 and 22 in FIG. 2B; Error bar: standard derivation;

FIG. 3 show imaging of a static 3D color scene according to an embodiment of an aspect of the present disclosure: FIG. 3A shows an experimental setup; FIG. 3B shows representative perspective images; FIG. 3C shows digital refocusing results;

FIG. 4 show 3D tracking of moving microspheres according to an embodiment of an aspect of the present disclosure: FIG. 4A shows an experiment setup; FIG. 4B shows representative depth-coded images; FIG. 4C shows 3D positions of five microspheres over time;

FIG. 5 show 3D tracking of a six-day-old freely moving zebrafish larva according to an embodiment of an aspect of the present disclosure; FIG. 5A shows representative all-focused frames at 100, 250, and 600 ms; FIG. 5B shows a 3D trace of a zebrafish; FIG. 5C shows instantaneous moving velocities of the zebrafish in the x-, y-, and z-directions; FIG. 5D shows time histories of the moving distance, tail bending angle, and fin orientation angle of the zebrafish;

FIG. 6 show a comparison of escape behaviors of a normal and disease-model (09-LOF) zebrafish: FIG. 6A shows representative all-focused frames at 50 ms, 150 ms, and 200 ms, depths are coded with different shades, backgrounds being subtracted for better display; FIG. 6B shows 3D traces after stimulation; FIG. 6C shows instantaneous moving velocities in the x-, y-, and z-directions;

FIG. 7A shows the ray-tracing result in the design of the dispersion eliminated coded-aperture light field (DECALF) imaging system;

FIG. 7B shows the simulated results of the five points in the field of view on the intermediate image plane (left panel) and the final image plane (right panel);

FIG. 7C shows the spot diagrams of the five points in the field of view; and

FIG. 8 shows a series of images of observation of the zebrafish's development using dispersion eliminated coded-aperture light field (DECALF) imaging.

### DESCRIPTION OF ILLUSTRATIVE EMBODIMENTS

The present invention is illustrated in further detail by the following non-limiting examples.

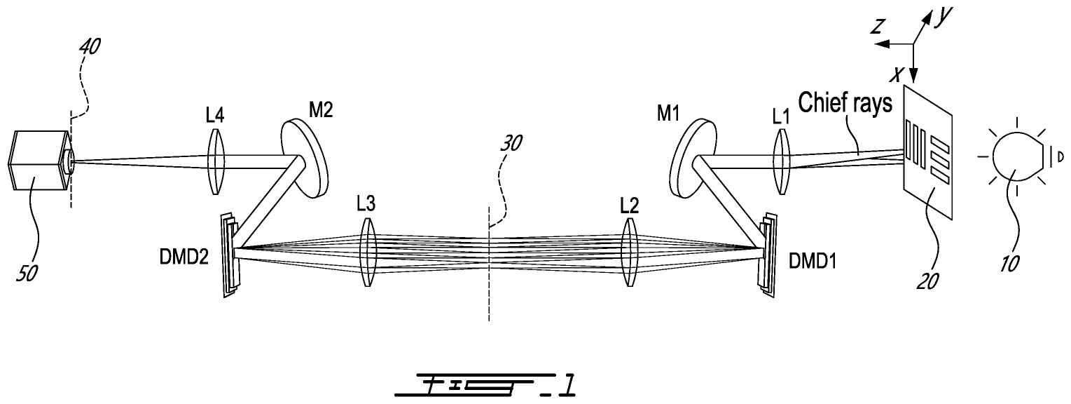

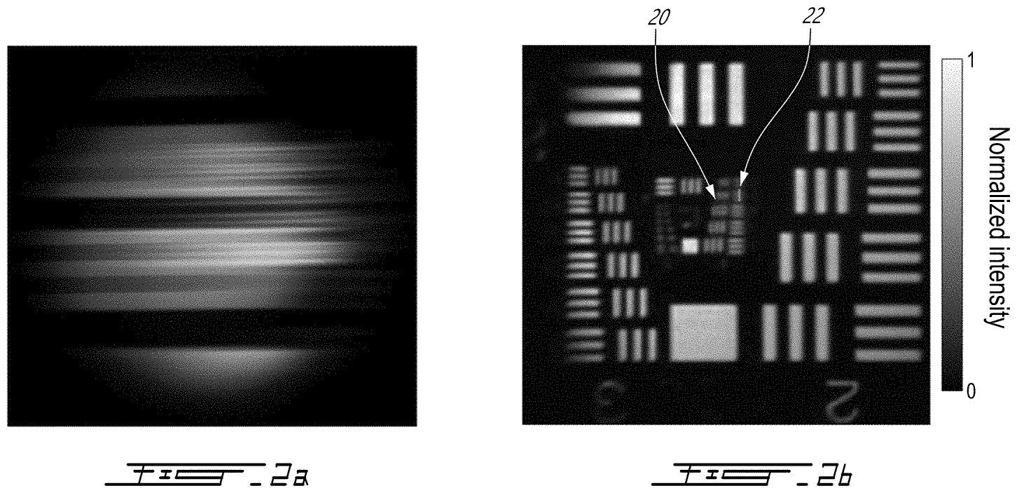

A dispersion-eliminated (DE) coded-aperture light field (CALF) imaging system for broadband light field imaging at video rate according to an embodiment of an aspect of the present disclosure is shown systematically in FIG. 1.

Broadband light from an object 20 illuminated by a light source 10 is imaged by a first 4f system consisting of lenses L1 and L2. A first digital micromirror device DMD1 placed on the back focal plane of the first lens L1 spatially disperses the incident light from the object 20 so that a spectrally smeared image of the object 20 is formed on an intermediate image plane 30. This image is relayed to a final image plane 40 by a second, identical, 4f system consisting of lenses L3 and L4 and a second digital micromirror device DMD2 placed on a back focal plane of the lens L3 of the second 4f system. As shown in FIG. 1, the chief rays from the object 20 stay parallel between the two digital micromirror devices DMD1 and DMD2. Since the two 4f systems are symmetrical about the intermediate image plane 30, the dispersion induced by the first digital micromirror device DMD1 is compensated, by the second digital micromirror device DMD, and a clear image of the object 20 is formed on a high-speed color camera 50 placed at the final image plane 40.

In experiments, the first digital micromirror device DMD1 divided the system's aperture into 5×5 square sub-apertures, each of which contained 50×50 micromirrors and had a 50% overlap with adjacent ones. An all-“OFF” pattern was loaded onto the second digital micromirror device DMD2. The camera 50 was synchronized with the first digital micromirror device DMD1. Overall, the system acquired 1280×1024×5×5 (x, y, θ, φ) light fields at 20 Hz.

A light emitting diode of spectral range from 400 nm to 700 nm (LED, Thorlabs, MNWHL4) was used in experiments as the light source 10. Other white light sources emitting light of wavelength in the range between about 400 and about 700 nm may be used.

The two 4f system are symmetric with respect to the intermediate plane 30. Both 4f systems had a focal length of their respective two lenses of 100 mm in experiments described herein. Optical lens with different focal lengths may be used. For example, the following lenses combinations may be used, i.e. 100 mm-150 mm-150 mm-100 mm or 100 mm-200 mm-200 mm-100 mm

A camera for scientific and industrial applications, PCO 1200 hs camera, was used in experiments described herein. Full color, full resolution light field imaging (5×5 perspective images) at a higher frame rate (more than 20 frames per second, fps), may be achieved using a color camera with a frame rate of at least 500 Hz.

A method for imaging the object according of the present disclosure generally comprises light field acquisition of two-dimensional (2D) spatial (x,y) and 2D angular (θ,φ) information of incident rays from the object and 3D reconstruction therefrom. For light field acquisition, the camera and the first digital micromirror device DMD1 are first synchronized, using the first digital micromirror device DMD1 as a master to synchronize with the camera; by loading different sub-aperture patterns onto the first digital micromirror device DMD1 with 500 frames per second, the trigger output pin of the controller board of the first digital micromirror device DMD1 provides a 500 Hz transistor-transistor logic (TTL) signal, which is then used as the external trigger signal of the camera, whereby the camera captures one image when it receives a rising edge of the transistor-transistor logic (TTL) signal. Then light field images are captured by opening different sub-apertures of the first digital micromirror device DMD1 one by one and loading all “OFF” pattern onto the second digital micromirror device DMD2. Experimentally, the different sub-aperture patterns are loaded onto the first digital micromirror device DMD1 with 500 frames per second by a controller software (ViALUX Discovery 4100 controller software), and the static all “OFF” pattern is loaded onto the second digital micromirror device DMD2 by a controller software (DLi Discovery 1100 controller software) selected to achieve high light throughput. The softwares depend on the model type of digital micromirror device.

For 3D reconstruction, in a system calibration step, different sub-aperture patterns are first loaded onto the first digital micromirror device DMD1, and the camera captures the 5×5 sub-aperture images. Then, the feature points are extracted in all sub-aperture images captured by the camera and the light field disparity (Δxᵢ, Δyⱼ) is determined; the angle (θᵢ, φⱼ) of each sub-aperture image is then obtained using the following relation: tanθ₁=Δxᵢ/f, and tanφⱼ=Δyⱼ/f, where f is the focal length of the first 4f system (FIG. 1). In a step of digital refocusing, a focal image at a distance Δz from the actual focal plane is reconstructed, by shifting each sub-aperture image by xᵢ=Δz tanθᵢ, yⱼ=Δz tanφj, and then adding together all the shifted images, using a shift-and-add algorithm.

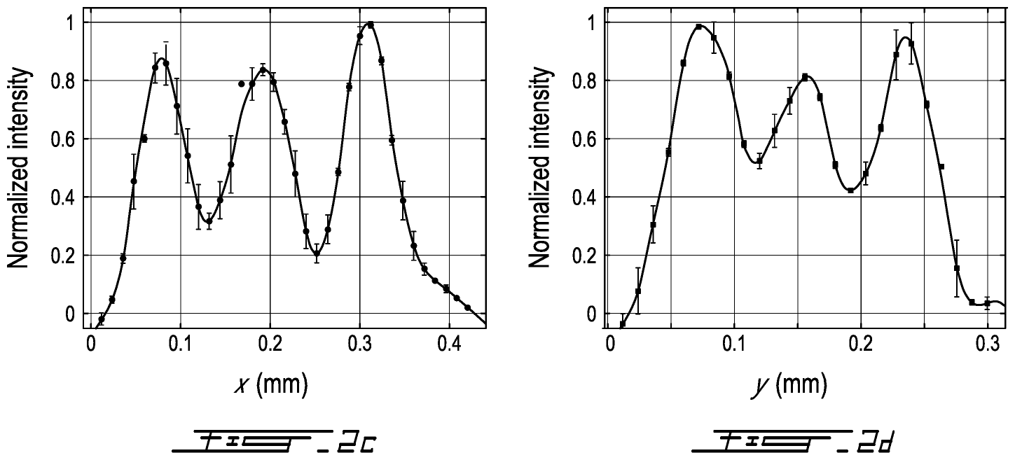

The characterization of the system was carried out by imaging a negative resolution object 20 (FIG. 1) illuminated by a white light-emitting diode 10 with a 400 nm-700 nm spectrum. An all-“OFF” pattern was loaded onto both the first and the second digital micromirror devices DMD1 and DMD2. The image captured on the intermediate image plane 30 (FIG. 1) shows severe dispersion induced by the first digital micromirror device DMD1. In contrast, a clear image of the resolution target was captured at the final image plane 40 (FIG. 1), demonstrating that the dispersion is compensated. The minimum resolvable feature sizes were quantified as 22.10 μm (Group 4, Element 4) in the horizontal direction (FIG. 2C) and 19.69 μm (Group 4, Element 5) in the vertical direction (FIG. 2D), in accordance with theoretical values. The slight difference in the two directions is likely attributed to the unmatched surface curves of the two digital micromirror devices DMD1 and DMD2. In addition, the axial resolution, depending on the pixel size of the camera 50 (FIG. 1) and the angular resolution of the system, was determined to be 1.24 mm. Finally, the imaging volume, relying on the (x, y) field of view and the depth of field of perspective images, was quantified to be 15.36×12.29×97.56 mm³.

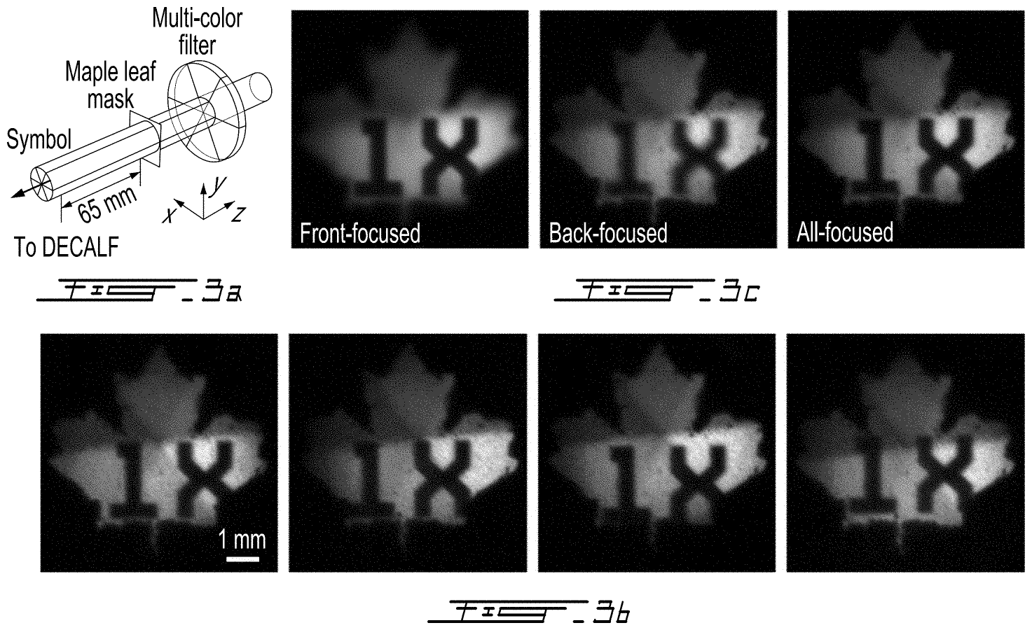

To demonstrate the system's performance, a static 3D color scene 10 was imaged. In the system of FIG. 3A, an incident white LED light was filtered by a multi-color filter (Izumar, Multi-color 58 mm). After that, a hollow maple-leaf mask and a “1X” symbol were placed at two depths separated by 64 mm. Perspective images were captured by sub-aperture scanning. FIG. 3B shows four representative perspective images captured by opening the leftmost, rightmost, topmost, and bottommost sub-apertures, respectively. The first two panels from the left handside illustrate the horizontal shift between the “1X” symbol and the maple-leaf mask by opening two different sub-apertures along the horizontal direction. Similarly, the vertical shift is evident in the last two panels, corresponding to the opening of two sub-apertures along the vertical direction. Moreover, all perspective images retain the full pixel count of the deployed color camera. Using these perspective images, the 3D scene was digitally refocused to the front, to the back, and over the entire scene (FIG. 3C). The distance between the “1X” symbol and the maple-leaf mask was quantified as 64.48 mm, in good agreement with the pre-set value.

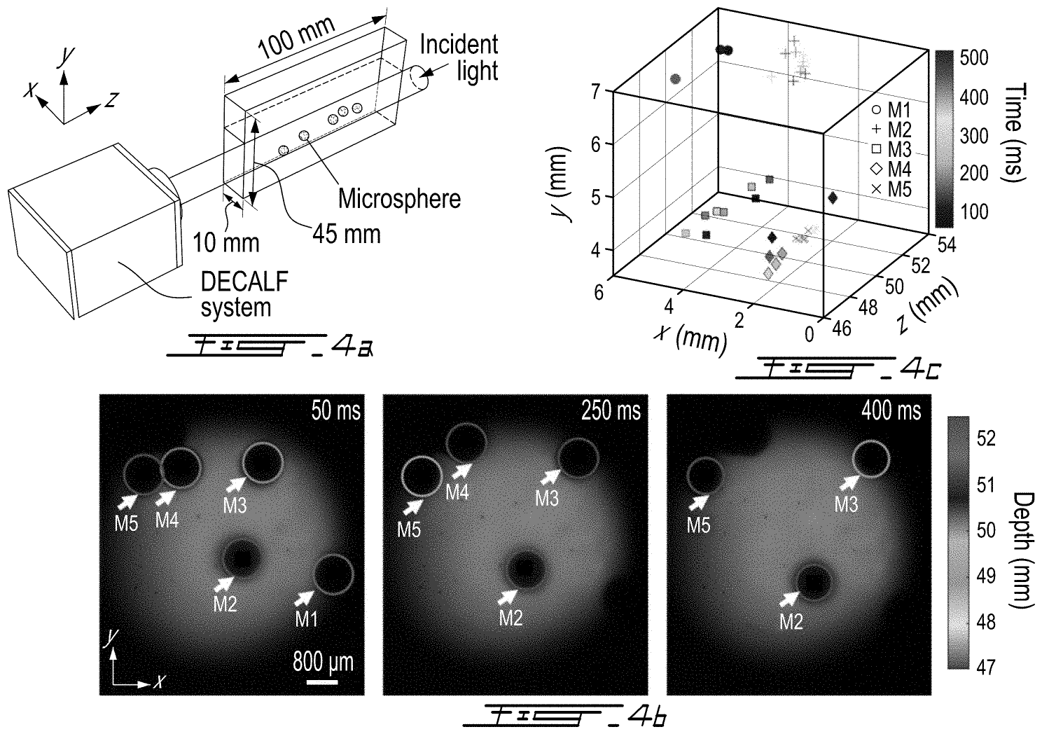

To demonstrate the imaging ability of the system to visualize dynamic objects, moving microspheres in water were imaged. A white LED illuminated polyethylene microspheres (Cospheric, WPMS-1.00 850-1000 μm) randomly distributed in water in a cuvette (Labshops, SKU:Q109), as schematically shown in FIG. 4A. The transmitted white light entered the system. Movement of the microspheres was induced by stirring the water. FIG. 4B shows three all-focused images at 50 ms, 250 ms, and 400 ms, in which the depths of the microspheres (marked as M1-M5) were determined via digital refocusing. By calculating the centroids of each microsphere, time histories of 3D positions of these microspheres are plotted in FIG. 4C. In this experiment, although the occlusion of microspheres was not observed, the system could mitigate such a problem, as the acquired perspective images enable viewing the scene from different angles, which increases the chance to observe occluded microspheres. Using the light-field occlusion modeling, the depths of the microspheres could be estimated by the system.

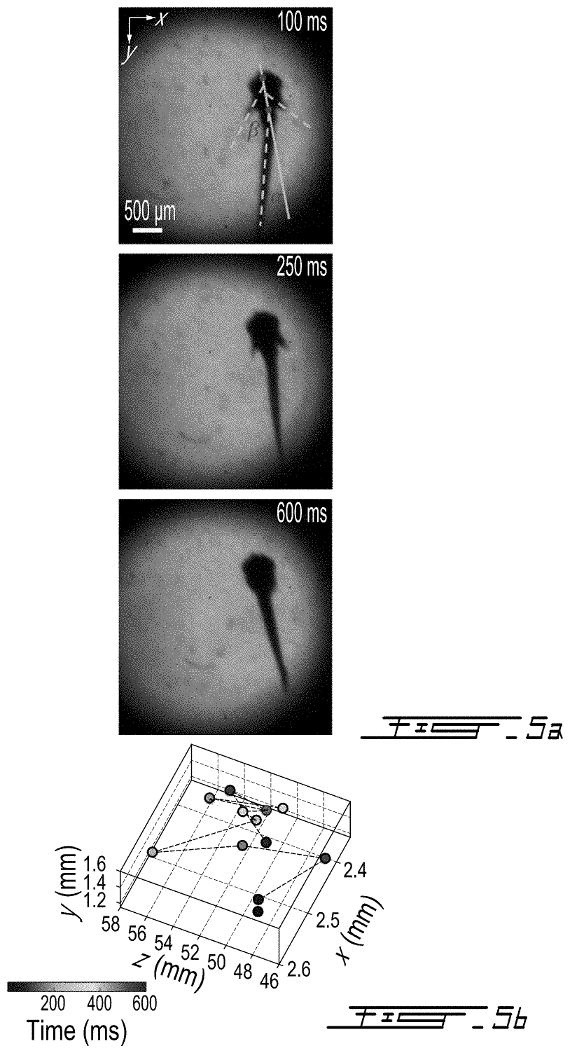

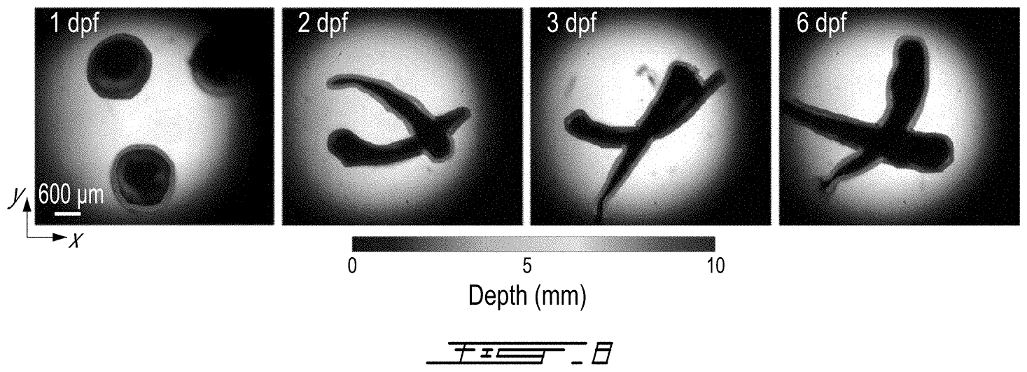

To highlight the dynamic 3D imaging ability of the system, a six-day-old larvae freely moving in a cuvette (Labshops, SKU:Q109) (FIG. 5, FIG. 8). Water jetting was used to stimulate escape behaviors of zebrafish. Three representative all-focused images of a zebrafish at 100 ms, 250 ms, and 600 are shown in FIG. 5A. The time trace of the 3D spatial positions of the head of this zebrafish is shown in FIG. 5B. Using this trace its instantaneous moving velocities was calculated in the x-, y-, and z-directions (FIG. 5C). To further analyze the zebrafish's motion, its tail bending angle α and its fin orientation angle β were tracked. Changes of these angles, along with the zebrafish's moving distance, are shown in FIG. 5D. These results illustrate the correlation between the distance and the instantaneous velocities of the zebrafish. In addition, the results show that the tail bending angle is zero at the beginning and the end of the recording window, indicating the zebrafish kept its tail straight when staying still. In contrast, once the zebrafish encountered a threatening stimulus, large tail bending angles were observed, resulting in a change of direction followed by a rapid swim with higher instantaneous velocities. These behaviors are reflected in FIG. 5C as a sharp oscillation in the moving trace from 100 ms to 350 ms. Finally, the data show asymmetrical orientation angles of the left and right fins, indicating drastic changes in direction during the zebrafish's escape from the stimulus.

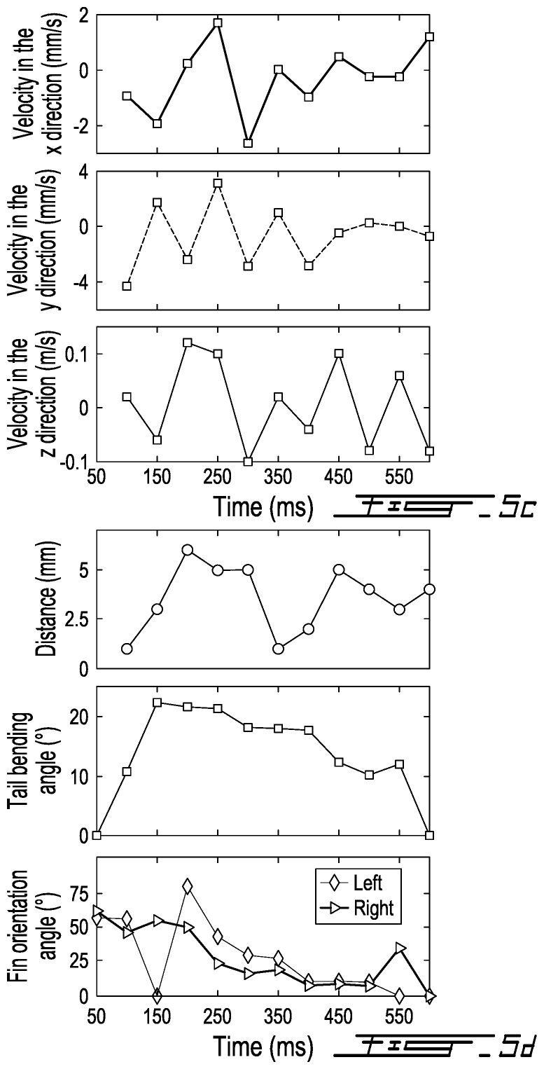

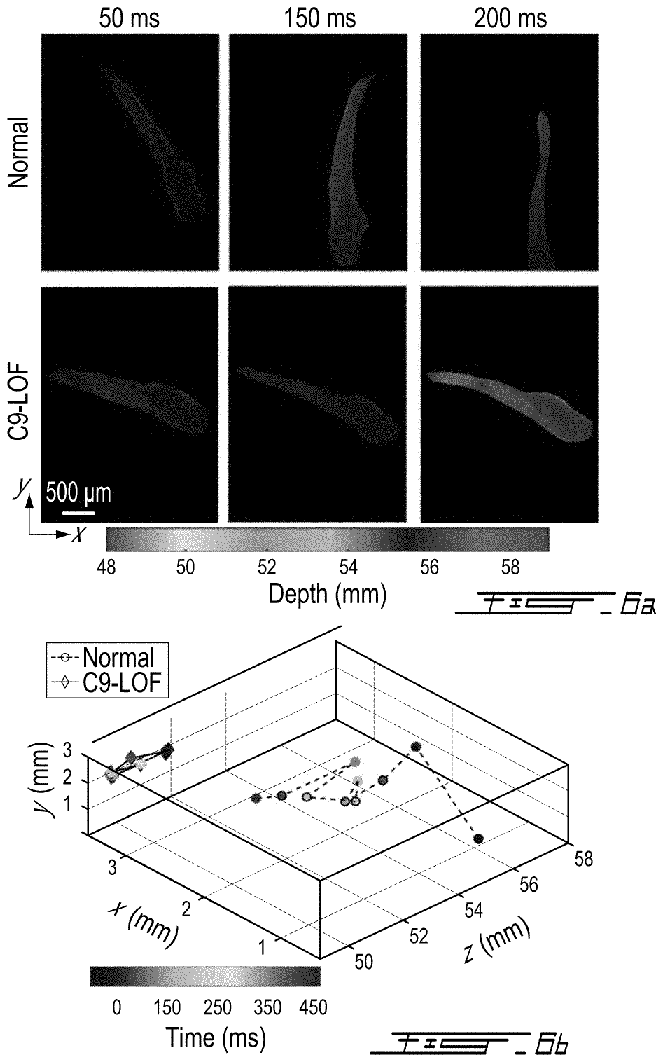

To evaluate the system's assessment of swimming behavioral differences in different zebrafish models, the system was applied to image a normal zebrafish and a C9ORF72 loss-of-function (C9-LOF) zebrafish. Recently developed to study the pathogenesis of amyotrophic lateral sclerosis, the C9-LOF zebrafish replicates aspects of this disease, including motor behavioural defects, muscle atrophy, and motor neuron loss. The representative all-focused frames of normal and C9-LOF 6-day old zebrafish larvae at three timepoints (FIG. 6A) show no apparent difference in their shapes. However, when water stream stimulation was applied, different behaviors were observed between normal and C9-LOF zebrafish by tracking their 3D positions (FIG. 6B). The normal zebrafish quickly moved away from the site of the startle. In contrast, the C9-LOF zebrafish showed slow responses and a limited moving ability due to motor deficits. This difference is quantitatively reflected in the instantaneous velocities of the normal and C9-LOF zebrafish in the x-, y-, and z-directions, as shown in FIG. 6C. While the curves for the normal zebrafish oscillate sharply in all three directions, those of the C9-LOF zebrafish show small changes, especially in the x-direction. Altogether, these results demonstrate the efficiency of the system applied to the behavioral study of disease-model zebrafish in vivo.

The system's performance as described herein above is mainly restricted by the frame rate of the color camera and the signal-to-noise rate (SNR) in the acquired images. The 500-Hz full frame rate in the deployed camera is much lower than the 22-kHz refreshing rate of the digital micromirror devices. The frame rate of light field imaging can be largely increased by replacing the camera with a high-speed imaging system. Meanwhile, the signal-to-noise rate (SNR) and accuracy in both the acquired perspective images and the recovered light field images can be enhanced by using advanced encoding. Moreover, by enlarging the angular range covered by the perspective images and by employing super-resolution algorithms in digital refocusing, the system may enable accurate depth sensing in the scenario of partial occlusion, shedding new light on in vivo high-speed 3D position tracking.

In summary, a digital micromirror device (DMD)—based coded-aperture light field (CALF) imaging system and method for high-resolution, color light field acquisition using broadband visible light at video rate are thus presented herein. The imaging system and method are shown herein applied to studying zebrafish's motion under stimulation. Circumventing the trade-off between spatial and angular resolutions, the system and method enable 5×5 (θ, φ) perspectives at the camera full (x, y) pixel count of 1280×1024. The system and method extend the operation scope of digital micromirror device (DMD)-based coded-aperture light field (CALF) to broadband light. As a universal imaging scheme, they may be integrated into a variety of modalities for both macroscopic and microscopic light field imaging. Compared with conventional coded-aperture light field (CALF) imaging that employs a single digital micromirror device (DMD) with a narrow-bandpass filter or monochromatic illumination, the present system and method enhance light throughput over the full visible spectrum. The dispersion-compensated system also avoids the reduction of spatial resolution by pixel binning and the decrease of image quality due to laser speckles. Furthermore, the broadband imaging circumvents the potential color-induced complexity in the study of animal behaviors.

The imaging system and method for broadband light field imaging at video rate as described in the present disclosure is based on a dual-digital micromirror devices (DMDs) configuration. Because the system is a symmetrical system, the first digital micromirror device induced spatial dispersion can be compensated by the second digital micromirror device, both digital micromirror devices being placed at the Fourier space of the system.

There is thus provided a dispersion-eliminated (DE) coded-aperture light field (CALF) imaging system and method. Using a dual-DMD system to compensate for dispersion in the visible spectrum, the dispersion-eliminated (DE) coded-aperture light field (CALF) imaging system captures 1280×1024×5×5 (x,y,θ,φ) color light field images at 20 Hz. Using static and dynamic three-dimensional (3D) color scenes, multi-perspective viewing, digital refocusing, and 3D tracking of the dispersion-eliminated (DE) coded-aperture light field (CALF) imaging were experimentally demonstrated. They were also applied to the imaging and analyses of escape behaviors of freely moving normal and disease-model zebrafish.

As people in the art will appreciate, digital micromirror devices (DMDs) are thus used to achieve color light field imaging using broadband light. The dispersion-eliminated (DE) coded-aperture light field (CALF) imaging system has state-of-the-art technical specifications by exhibiting high frame rates and retaining full camera pixel counts and has six-dimensional data acquisition ability. The dispersion-eliminated (DE) coded-aperture light field (CALF) imaging enables dynamic in vivo imaging for any coded-aperture light field (CALF) systems.

The dispersion-eliminated (DE) coded-aperture light field (CALF) imaging system and method provide a generic platform for DMDs-based broadband light field imaging, significantly advancing the imaging capability and application scope, of interest in the community of light field imaging.

The dispersion-eliminated (DE) coded-aperture light field (CALF) imaging system and method can be integrated into photography, microscopy, and endoscopy for both macroscopic and microscopic imaging. They are of a general interest in the communities of optical engineering, imaging science, and biophotonics for example.

Application of the dispersion-eliminated (DE) coded-aperture light field (CALF) imaging system and method to three-dimensional dynamic imaging of a zebrafish in its movement as reported herein are of interest to scientists in developmental biology and neuroimaging for technology adoption for example.

The present system and method may find applications in the field of light field imaging, three-dimensional sensing, microscopy, and endoscopy for example

ANNEX:

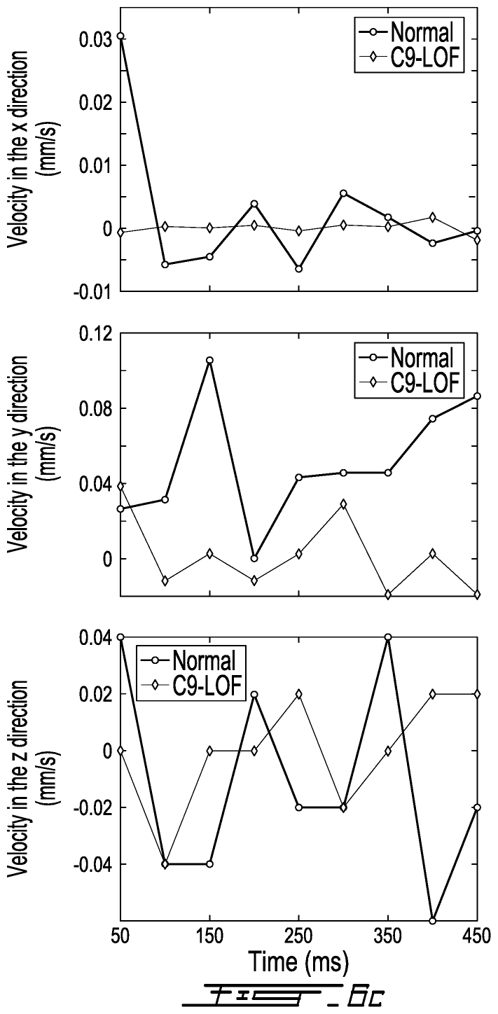

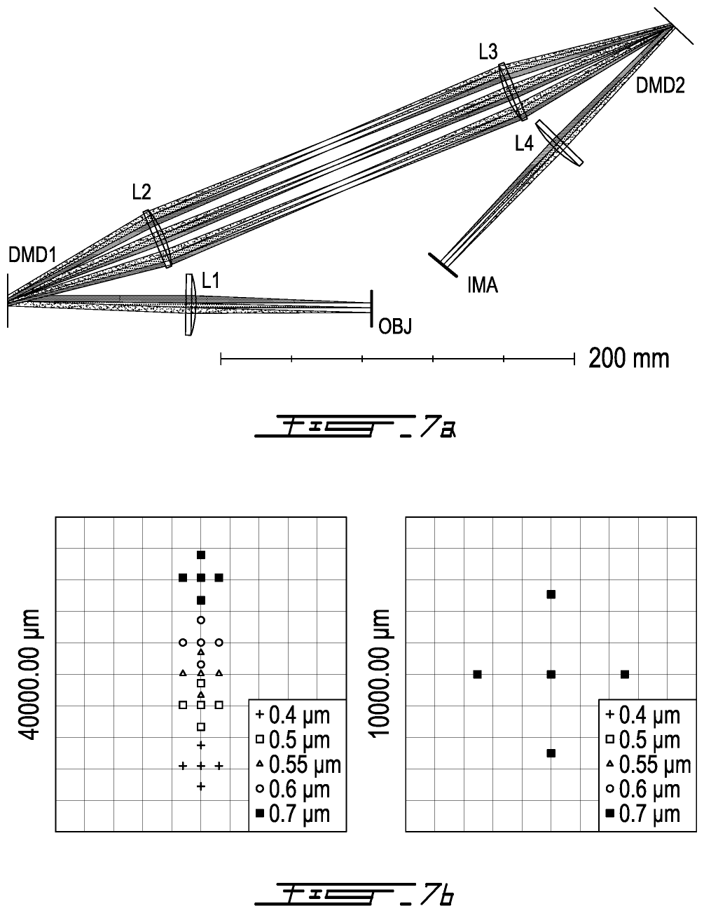

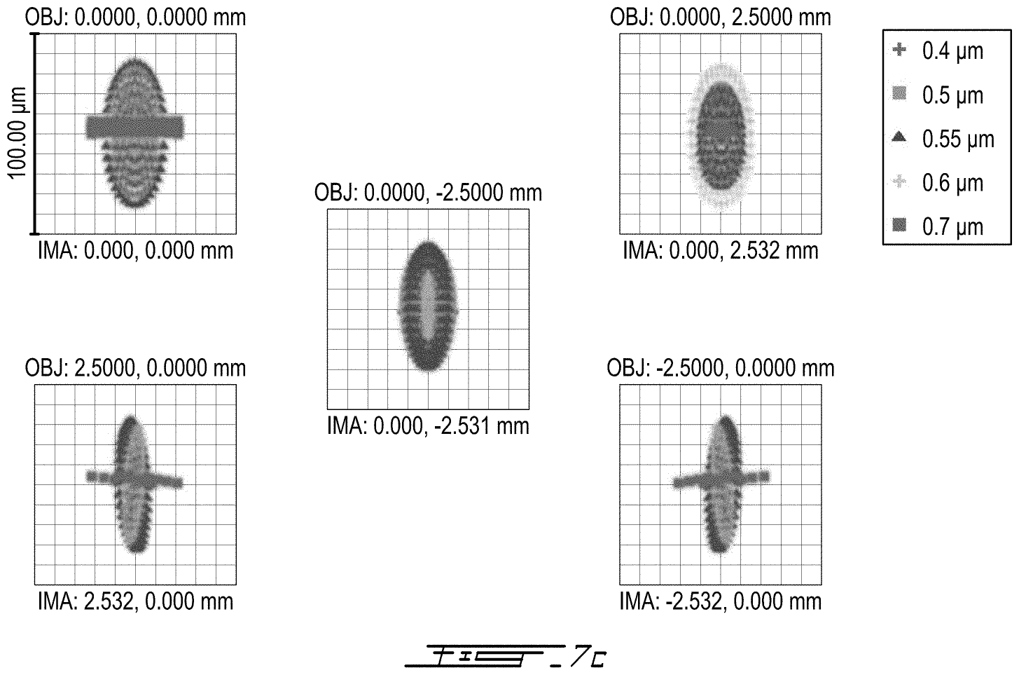

FIG. 7A shows the ray-tracing result of the dispersion-eliminated coded-aperture light field (DECALF) system using an optical design program (Zemax). The models of the lenses (used in the setup were directly downloaded from an online resource. Five points in the field of view (FOV) with the (x, y) coordinates of (−2.5 mm, 0 mm), (0 mm, 0 mm), (2.5 mm, 0 mm), (0 mm, −2.5 mm), and (0 mm, 2.5 mm) were ray-traced for five wavelengths in the 400 nm-700 nm spectral range. FIG. 7B shows the simulated results of these five points on the intermediate image plane (left panel) and the final image plane (right panel), respectively. This result proves the dispersion-eliminated coded-aperture light field (DECALF) imaging system's dispersion compensation ability. Finally, the spot diagrams on the final image plane are shown in FIG. 7C, which indicates that a mean spot radius of 14.57 μm over the FOV.

In an experiment, a first dispersion-eliminated coded-aperture light field (DECALF) imaging system was constructed, using a 300 lp/mm one-dimension (1D) transmission grating with a single-lens imaging system. Because of the different densities between the DMD and this 1D grating, the compensation was extremely sensitive to the lens position. Moreover, it was found that the dispersion in the visible spectral range (i.e., 400 nm-700 nm) could not be completely compensated over the entire field of view (FOV). In a second dispersion-eliminated coded-aperture light field (DECALF) imaging system, a second identical DMD and an unpowered 0.7″ XGA DMD chip were used, which resulted in improved dispersion compensation. However, because the micromirrors could not be set to either “ON” or “OFF” state, the diffraction efficiency of the DMD was extremely low (<1%). In a third system, a DMD development module (Texas Instrument, Discovery 1100) was used and loaded an all-“OFF” pattern, and a 4f imaging system was used for easier alignment, which result in full dispersion compensation with a good light throughput.

For additional result for zebrafish imaging using the dispersion-eliminated coded-aperture light field (DECALF) system, the dispersion-eliminated coded-aperture light field (CALF) imaging system was used for observation of the development of zebrafish. FIG. 8 shows depth-coded images of two zebrafish at four different stages of development: 1 day post-fertilization (dpf), 2 dpf, 3 dpf, and 6 dpf. The zebrafish started hatching out of their chorion as of 2 dpf. Their length increased from 2.3 mm (2 dpf) to 4.0 mm (6 dpf).

The scope of the claims should not be limited by the embodiments set forth in the examples but should be given the broadest interpretation consistent with the description as a whole.

1. A method for broadband coded aperture light field imaging of an object, comprising illuminating the object with a broadband light source; imaging a broadband light emitted by the illuminated object and forming a first image of the object on an intermediate image plane, relaying the first image to a final image plane and forming a final image of the object on a camera placed at the final image plane.

2. The method of claim 1, wherein the broadband light emitted by the illuminated object is imaged by a first 4f imaging system and spatially dispersing the broadband light using a first digital micromirror device placed on a back focal plane of a first lens of the first 4f imaging system, thereby forming a first spectrally smeared image of the object on the intermediate image plane, and the first image is relayed to the final image plane using the second 4f system and a second digital micromirror device, the first and the second 4f systems being symmetrical with respect to the intermediate image plane.

3. The method of claim 1, wherein the broadband light emitted by the illuminated object is imaged by a first 4f imaging system and spatially dispersing the broadband light using a first digital micromirror device placed on a back focal plane of a first lens of the first 4f imaging system, thereby forming a first spectrally smeared image of the object on the intermediate image plane, and the first image is relayed to the final image plane using a second 4f system and a second digital micromirror device, the first and the second 4f systems being symmetrical with respect to the intermediate image plane, and wherein chief rays from the object are parallel between the first and the second digital micromirror devices.

4. The method of claim 1, wherein the broadband light emitted by the illuminated object is imaged by a first 4f imaging system and spatially dispersing the broadband light using a first digital micromirror device placed on a back focal plane of a first lens of the first 4f imaging system, thereby forming a first spectrally smeared image of the object on the intermediate image plane, and the first image is relayed to the final image plane using a second 4f system and a second digital micromirror device, the first and the second 4f systems being symmetrical with respect to the intermediate image plane, wherein dispersion induced by the first digital micromirror device is compensated by the second digital micromirror device.

5. The method of claim 1, comprising selecting a light source of a wavelength in a range between 400 nm and 700 nm.

6. The method of claim 1, comprising selecting a high-speed color camera.

7. The method of claim 1, comprising selecting a color camera with a frame rate of at least 500 Hz.

8. A method for imaging an object, comprising light field acquisition of two-dimensional spatial (x,y) and two-dimensional angular (θ,φ) information of incident rays from the object and 3D reconstruction of the object, the method comprising:
illuminating the object with a broadband light source and directing a broadband light emitted from the illuminated object to a first 4f system and a second 4f system, the first 4f system and the second 4f system being symmetrical about an intermediate image plane;
wherein:
said light field acquisition comprises synchronizing a camera and a first digital micromirror device placed on a back focal plane of a first lens of the first 4f system; capturing light field images by opening sub-apertures of the first digital micromirror device one by one and loading all “OFF” pattern onto a second digital micromirror device placed on a back focal plane of a first lens of the second 4f system;
said 3D reconstruction comprises, in a system calibration step, loading sub-aperture patterns onto the first digital micromirror device, and capturing sub-aperture images by a camera;
extracting feature points in the sub-aperture images captured by the camera, determining a light field disparity (Δxᵢ, Δyⱼ) and an angle θᵢ, φⱼ) of each sub-aperture using a light field disparity (Δxᵢ, Δyⱼ) as: tanθᵢ=Δxᵢ/f, and tanφⱼ=Δyⱼ/f, where f is a focal length of the first lens of the first 4f system; and, in a digital refocusing step, reconstructing a focal image at a distance Δz from an actual focal plane, by shifting each sub-aperture image by xᵢ=Δz tanθᵢ, yⱼ=Δz tanφⱼ, and adding together resulting shifted images.

9. The method of claim 8, wherein said synchronizing the camera and the first digital micromirror device comprises loading sub-aperture patterns onto the first digital micromirror device and using a transistor-transistor logic signal of the first digital micromirror device as an external trigger signal of the camera, whereby the camera captures an image when the camera receives a rising edge of the transistor-transistor logic signal.

10. The method of claim 8, wherein said capturing the light field images comprises opening sub-apertures of the first digital micromirror device one by one and loading all “OFF” pattern onto a second digital micromirror device placed on a back focal plane of a first lens of the second 4f system.

11. The method of claim 8, wherein said reconstructing of the focal image at the distance Δz from the actual focal plane comprises shifting each sub-aperture image by xᵢ=Δz tanθᵢ, yⱼ=Δz tanφⱼ, and adding together resulting shifted images.

12. The method of claim 8, comprising selecting the broadband light source as a light source of a wavelength in a range between 400 nm and 700 nm.

13. The method of claim 8, comprising selecting the camera as a color camera with a frame rate of at least 500 Hz.

14. A system for broadband coded aperture light field imaging of an dynamic object,
comprising:
a broadband light source;
a first and a second digital micromirror devices;
a first 4f imaging system and a second 4f imaging system, symmetrical about an intermediate image plane;
a high speed camera;
wherein said broadband light source illuminates the object, said first 4f imaging system and said second 4f imaging system images broadband light from the illuminated object on the intermediate image plane and on a final image plane; and said camera captures images at the final image plane, the first digital micromirror device induced spatial dispersion being compensated by the second digital micromirror device, both digital micromirror devices being placed at the Fourier plane of the respective 4f imaging systems.

15. The system of claim 14, wherein said broadband light source is selected as a light source of a wavelength in a range between 400 nm and 700 nm.

16. The system of claim 14, wherein said camera is selected as a color camera with a frame rate of at least 500 Hz.
